(19) United States
(12) Patent Application Publication
(10) Pub. No.: US 2014/0122179 A1
(43) Pub. Date: May 1, 2014

(54) METHOD AND SYSTEM FOR DETERMINING LONG RANGE DEMAND FORECASTS FOR PRODUCTS INCLUDING SEASONAL PATTERNS

(71) Applicant: Teradata Corporation, Dayton, OH (US)

(72) Inventors: Tsz Yu Chan, Boston, MA (US); Arash Bateni, Toronto (CA)

(73) Assignee: Teradata Corporation, Dayton, OH (US)

(21) Appl. No.: 14/068,292

(22) Filed: Oct. 31, 2013

Related U.S. Application Data
(60) Provisional application No. 61/721,227, filed on Nov. 1, 2012.

(51) Int. Cl. G06Q 30/02

(52) U.S. Cl. CPC G06Q 30/0202
USPC 705/7.31

(57) ABSTRACT

An improved method and system for forecasting product demand using a causal methodology, based on multiple regression techniques. The improved causal method identifies year-over-year trending effects within historical product demand data, removes the trending effects from the calculation of seasonal factors used in determining product demand forecasts, calculates trend factors from the identified trending effects, and applies the trend factors and de-trended seasonal factors to initial product demand forecasts when determining final demand forecasts for the products.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/721,227, entitled “IMPROVED METHOD AND SYSTEM FOR DETERMINING LONG RANGE DEMAND FORECASTS FOR PRODUCTS INCLUDING SEASONAL PATTERNS,” filed on Nov. 1, 2012, by Arash Bateni and David Chan.

This application is related to the following commonly-assigned patents and patent applications, which are incorporated by reference herein:

application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger;

application Ser. No. 11/967,645, entitled “TECHNIQUES FOR CAUSAL DEMAND FORECASTING,” filed on Dec. 31, 2007, by Arash Bateni, Edward Kim, J. P. Vorsanger, and Rong Zong;

application Ser. No. 12/644,053, entitled “SYSTEM AND METHOD FOR DE-SEASONALIZING PRODUCT DEMAND BASED ON MULTIPLE REGRESSION TECHNIQUES,” filed on Dec. 22, 2009, by Edward Kim and Arash Bateni; and

U.S. Pat. No. 7,996,254, entitled “IMPROVED METHODS AND SYSTEMS FOR FORECASTING PRODUCT DEMAND DURING PROMOTIONAL EVENTS USING A CAUSAL METHODOLOGY,” issued on Aug. 9, 2011, by Arash Bateni, Edward Kim, Harmintar Atwal, and J. P. Vorsanger.

### FIELD OF THE INVENTION

The present invention relates to methods and systems for forecasting product demand using a causal methodology, based on multiple regression techniques, and in particular to an improved method which identifies year-over-year trending effects within historical product demand data, removes the trending effects from the calculation of seasonal factors used in determining product demand forecasts, calculates trend factors from the identified trending effects, and applies the trend factors and de-trended seasonal factors to initial product demand projections when determining demand forecasts for the products.

### BACKGROUND OF THE INVENTION

Accurate demand forecasts are crucial to a retailer's business activities, particularly inventory control and replenishment, and hence significantly contribute to the productivity and profit of retail organizations.

Aprimo, a division of Teradata Corporation, has developed a suite of analytical applications for the retail business, referred to as Aprimo Demand Chain Management (DCM), which provides retailers with the tools they need for product demand forecasting, planning and replenishment. The Aprimo Demand Chain Management forecasting application assists retailers in accurately forecasting product sales at the store/SKU (Stock Keeping Unit) level to ensure high customer service levels are met, and inventory stock at the store level is optimized and automatically replenished. The Aprimo DCM forecasting application helps retailers anticipate increased demand for products and plan for customer promotions by providing the tools to do effective product forecasting through a responsive supply chain.

In application Ser. Nos. 11/613,404; 11/967,645; 12/644,053; and U.S. Pat. No. 7,996,254, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these references seek to establish a cause-effect relationship between product demand and factors influencing product demand in a market environment. Such factors may include current product sales rates, product price changes, promotional activities, competitive information, weather conditions, and other factors. A product demand forecast is generated by combining an uplift coefficient determined through regression analysis of the of causal factors influencing product demand, with an Average Rate of Sale (ARS) value generated by the DCM application, and a seasonal factor selected for the product.

Presented below is an improved product demand forecast method which identifies year-over-year trending effects within historical product demand data, removes the trending effects from the calculation of seasonal factors used in determining product demand forecasts, and calculates and applies trend factors when determining demand forecasts for the products.

### BRIEF DESCRIPTION OF THE DRAWINGS

FIG. 1 provides a high level architecture diagram of a web-based three-tier client-server computer system architecture.

FIG. 2 provides an illustration of the Aprimo DCM forecasting, planning and replenishment software application suite shown in FIG. 1.

FIG. 3 is a flow chart illustrating a method for determining product demand forecasts utilizing a multivariable regression model to model the causal relationship between product demand and the attributes of past sales activities.

FIG. 4 is a graph illustrating the effect of year-over-year trend within seasonal factors on different products having the same seasonal model.

FIGS. 5A and 5B are graphs illustrating the effect of year-over-year trend on seasonal factors between sales years.

FIGS. 6A and 6B are graphs illustrating apparent sales trends caused by normal seasonality of product sales.

FIG. 7 is a flow chart illustrating a method for determining seasonal factors which removes trending effects from the calculation of seasonal factors.

FIGS. 8A and 8B are graphs illustrating the differences between example demand data and seasonal factors following the removal of trend effects from demand data.

FIG. 9 is a graph illustrating possible errors in long range product demand forecasts due to trend effects in historical demand data and seasonal factors calculations.

FIG. 10 is a flow chart illustrating an improved method for determining product demand forecasts with a trend factor applied to the long range product demand forecast in accordance with the present invention.

FIG. 11 is a graph providing a comparison of long range product demand forecasts including a forecast determined with trend effects removed from historical demand data, and a forecast with a trend factor applied to the long range product demand forecast in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the causal demand forecasting methodology seeks to establish a cause-effect relationship between product demand and factors influencing product demand in a market environment. A product demand forecast is generated by blending the various influencing factors in accordance with corresponding regression coefficients determined through the analysis of historical product demand and factor information. The multivariable regression equation can be expressed as:

LN=base+α₁var₁+α₂var₂+ . . . +αₙvarₙ;

where LN represents demand uplift; var₁ through varₙ represent causal variables, such as current product sales rate, product price, weather, promotional activities, and other factors; and α₁ through αₙ represent regression coefficients determined through regression analysis using historical sales, price, promotion, and other causal data.

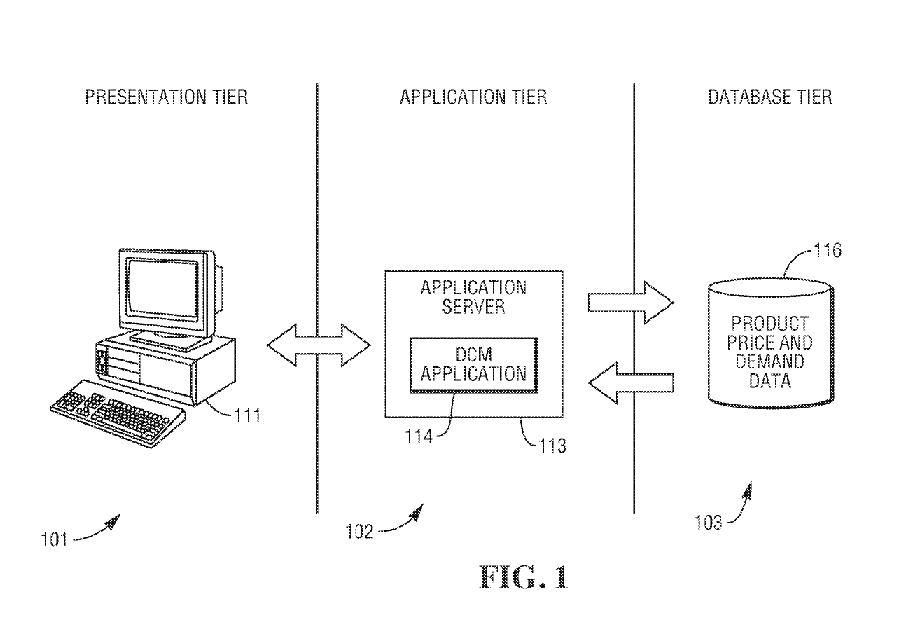

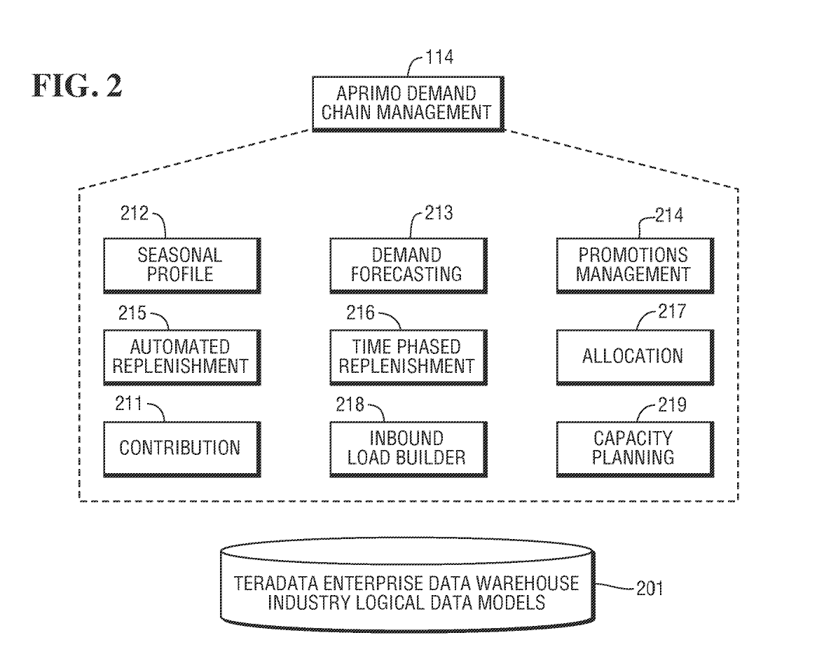

The Aprimo DCM Application Suite may be implemented within a three-tier computer system architecture as illustrated in FIG. 2. The three-tier computer system architecture is a client-server architecture in which the user interface, application logic, and data storage and data access are developed and maintained as independent modules, most often on separate platforms. The three tiers are identified in FIG. 1 as presentation tier 101, application tier 102, and database access tier 103.

Presentation tier 101 includes a PC or workstation 111 and standard graphical user interface enabling user interaction with the DCM application and displaying DCM output results to the user. Application tier 103 includes an application server 113 hosting the DCM software application 114. Database tier 103 includes a database server containing a database 116 of product price and demand data accessed by DCM application 114.

As illustrated in FIG. 2 the Aprimo Demand Chain Management analytical application suite 114 is shown to be part of a data warehouse solution for the retail industries built upon Teradata Corporation's Teradata Data Warehouse 201, using a Teradata Retail Logical Data. Model (RLDM). The key modules contained within the Aprimo Demand Chain Management application suite 114, are:

Contribution: Contribution module 211 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module, also referred to as the Intelligent Profile Clustering (IPC) module, 212 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 213 provides store/SKU level forecasting that responds to unique local customer demand. This module considers both an item's seasonality and its rate of sales (sales trend) to generate an accurate long range demand forecast (up to the next 65 weeks). The module continually compares historical and current demand data and utilizes several methods to determine the best product demand forecast.

Promotions Management: The Promotions Management module 214 automatically calculates the precise additional stock needed to meet demand resulting from promotional activity.

Automated Replenishment: Automated Replenishment module 215 provides the retailer with the ability to manage replenishment both at the distribution center and the store levels. The module provides suggested order quantities based on business policies, service levels, forecast error, risk stock, review times, and lead times.

Time Phased Replenishment: Time Phased Replenishment module 216 Provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 217 uses intelligent forecasting methods to manage pre-allocation, purchase order and distribution center on-hand allocation.

Load Builder: Load Builder module 218 optimizes the inventory deliveries coming from the distribution centers (DCs) and going to the retailer's stores. It enables the retailer to review and optimize planned loads.

Capacity Planning: Capacity Planning module 219 looks at the available throughput of a retailer's supply chain to identify when available capacity will be exceeded.

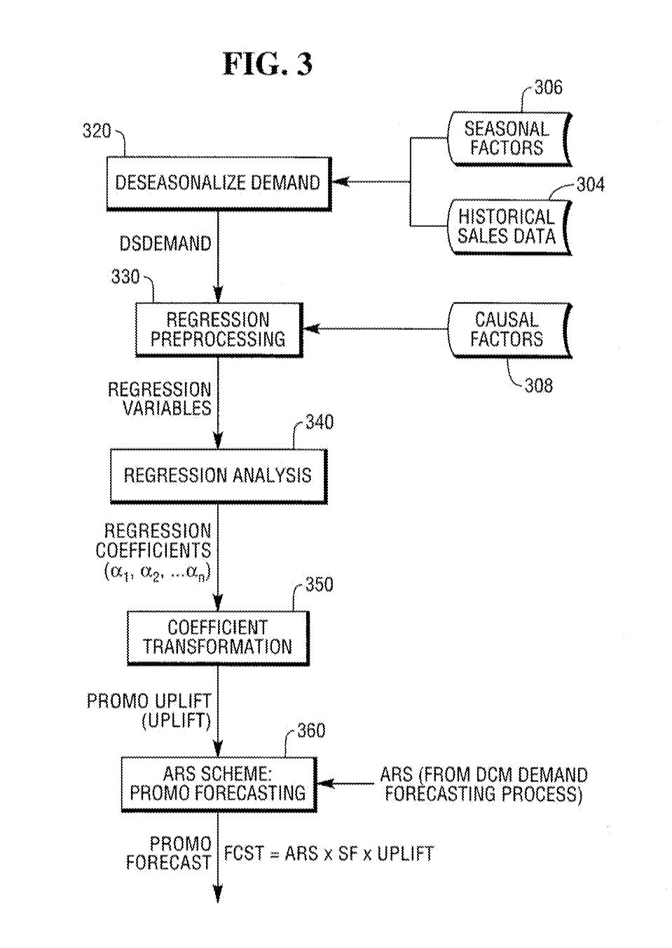

FIG. 3 is a flow chart illustrating a casual method for forecasting promotional product demand, as described in greater detail in U.S. Pat. No. 7,996,254 and U.S. patent application Ser. No. 12/644,053, referred to above. The demand forecasting technique described therein employs a multivariable regression model to model the causal relationship between product demand and the attributes of past promotional activities. The model is utilized to calculate the promotional uplift from the coefficients of the regression equation. The methodology consists of two main steps a) regression: calculation of regression coefficients, and b) coefficient transformation: calculation of the promo uplift.

Referring to FIG. 3, historical sales data 304, seasonal adjustment factors (SFs) 306, and tracked causal factors 308, are saved for each product or service offered by the retailer.

In step 320, the historical demand data for products having seasonal selling patterns is adjusted, i.e., deseasonalized, by dividing the actual historical demand values by their corresponding seasonal factors according to equation 1, dsdemand_{yr,wk}=demand_{yr,wk}/SF_{wk}. The seasonally adjusted demand (dsdemand) is then used as input to the causal framework and the forecasting module of the DCM forecasting application.

In step 330, regression preprocessing is performed to select the set of causal factors that have statistically significant effects on historical product demand, and to prepare the causal factor data 308 for analysis.

In step 340, regression coefficients (α₁, α₂, α₃, . . . αₙ) are calculated using the deseasonalized demand data and tracked causal factors 308. These regression coefficients are combined in step 350 to generate an uplift coefficient for each product.

In step 360, the uplift coefficients are combined with the DCM Average Rate of Sale (ARS) calculation results provided by the forecasting module of the DCM forecasting application (an initial product demand forecast) for the product, and the appropriate seasonal factors provided by seasonal profile (IPC) module, to generate the final product demand forecast for the product:

FCST=ARS×SF×UPLIFT

As stated above, causal factors may include current product sales rates, seasonality of demand, product price changes, promotional activities, competitive information, weather conditions, and other factors.

### Removal of Trend Effect from Seasonal Factor Calculations

The seasonal pattern associated with a product is a major factor in the accuracy of product long range forecasts, contributing up to 50% of the total forecast accuracy. The DCM seasonal profiling module 212, also referred to as Intelligent Profile Clustering module, or IPC module, is used to group similar items together and generate seasonal factors (patterns). The seasonal factors created by the IPC module are thereafter used in the DCM Automated Replenishment (AR) module 215 to generate product long range sales and order forecasts.

The IPC module uses up to four years of actual sales history as input for seasonal factor calculations. However, this sales history may contain year-over-year trend contribution on top of the seasonal patterns. As the former IPC module does not include any de-trending logic to filter out the year-over-year trending effect, the seasonal factors created by this IPC module have the trending factor included.

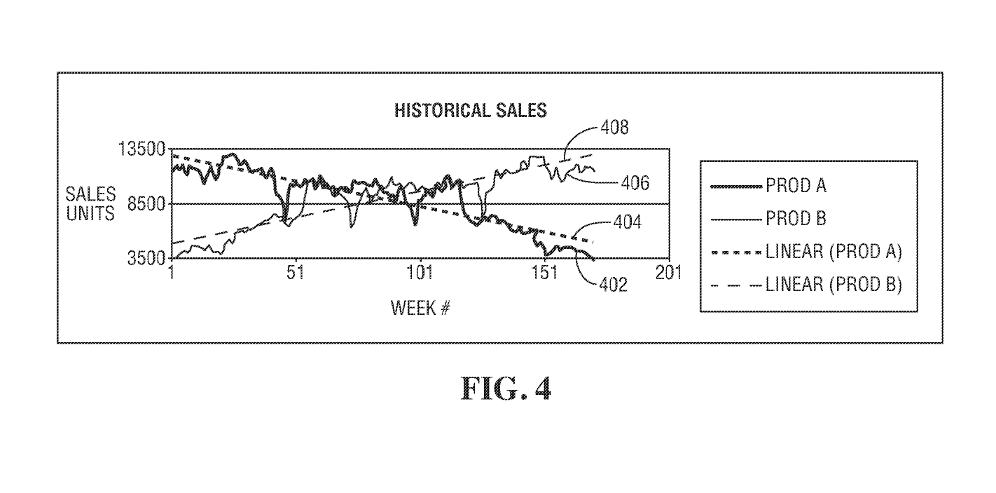

Leaving the year-over-year trend contribution in the seasonal factors will cause two major issues. First, as illustrated in FIG. 4, not all products (SKUs) within a seasonal model have the same trend. Therefore, the effect on the forecast accuracy for each individual SKU within a seasonal model may vary. FIG. 4 provides an illustration of two products, PROD A and PROD B, having the same seasonal pattern. The sales history for PROD A, including a downward trend, is illustrated in graph 402 and, linearly, in graph 404; while the sales history for PROD B, including an upward trend, is illustrated in graph 406 and, linearly, in graph 408.

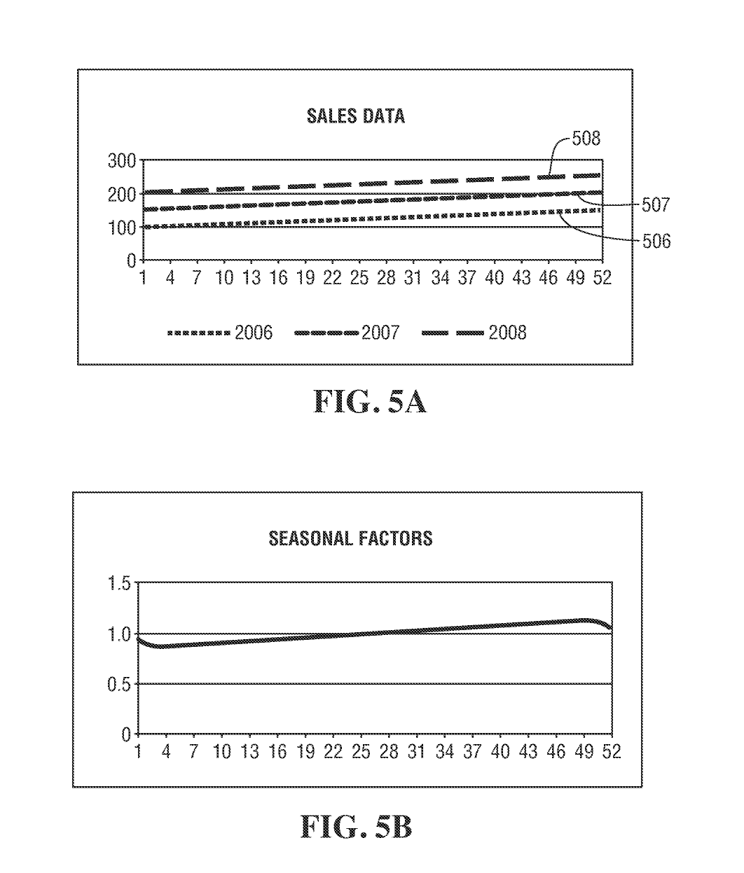

The second issue resulting from leaving the year-over-year trend in the seasonal factors, is that a higher than normal gap between week fifty-two and week one, known as wrap-around gap, results, as shown in FIGS. 5A and 5B. FIG. 5A provides example product sales data for three years, 2006 through 2008, shown graphically in graph lines 506, 507, and 508, respectively. As illustrated, the sales data is linear, but includes an upward trend, with each successive year continuing the trend from the immediately prior year. FIG. 5B shows the seasonal pattern calculated from the data of FIG. 5B, including the upward trend and errors in the week 1 and week 52 seasonal factors.

To remove trend effects on seasonal model and seasonal factor calculations, new logic is included within the IPC module. In the development of this new logic a linear (or additive) trend, not an exponential or multiplicative trend was assumed. It was also assumed that trend is constant throughout the collected product demand history. The solution does not attempt to calculate different slopes for different portion of the history. Trend was also assumed to be in the form of y=a+b*t, where a=0, b is the weekly trend factor (additive weekly change in sales), and t is the week of history. Finally, trend should be determined and separated during calculations of both the Model and Product seasonal factors (model SF and prod SF).

In accordance with the de-trending logic, the trend is removed before calculating the seasonal factors in the IPC module, and stored as an additional forecast factor in the IPC module.

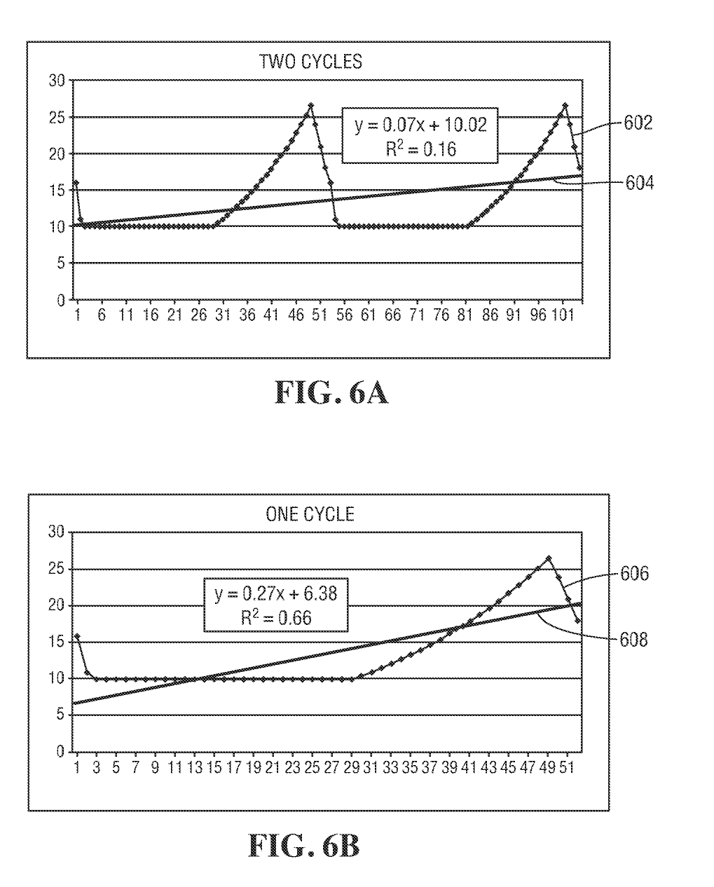

The normal seasonality within a year may appear as a trend. This “apparent” trend is different than the Year-over-Year (YoY) trend and should not be adjusted or removed. A line cannot be simply fitted to historical sales to calculate the slope as trend. This is an important consideration when there is less than two years of historical sales data available. The graphs of FIGS. 6A and 6B illustrate the apparent trends caused by normal seasonality of the sales. FIG. 6A illustrates product sales over two yearly cycles, i.e., 104 weeks. Graph 602 shows flat sales of 10 units per week for weeks 3 through 29, with increasing sales from week 30 through 48, followed by a steep drop in sales to begin the next year. The pattern for weeks 1 through 52 is identical to the pattern shown for weeks 52 through 104, having the same flat sales values for the first half of each year, and an increase to the same peak sales value during the second half of each year. Line 604 shows the average product sales over the 104 week period represented as a straight line having a slope of 0.07.

Graph line 606 of FIG. 6B shows one cycle, weeks 1 through 52, of the product sales illustrated in graph 602 of FIG. 6A. Line 608 shows the average product sales over the 52 week period represented as a straight line having a slope of 0.27. It is clear from an examination of FIGS. 6A and 6B that the calculated slopes are different than the YoY trend.

In the calculation of YoY trend, 52-week lags (called LAG52) are used, where LAG52 is the change in demand from the same week a year earlier: LAG52=demand(yr,wk)−demand(yr−1,wk). When one of the two demands is not available, i.e., leading or trailing weeks, the LAG52 is not calculated (LAG52=NULL). If the missing week is in the middle, a demand of zero (0) is assumed. Week 53 demand is embedded into week 51, 52 or week 52, 01 demand. When there are “N” weeks of history available, then up to N−52 lags are calculated. Trend is not calculated if any of the conditions are not satisfied.

Weekly trend is calculated as average(LAG52)/52.

To assure a minimum quality of trend, a statistical test is applied to determine the significance of the observed trend. YoY trend will only be calculated when an item or model passes the following conditions:
The minimum sales volume: the average weekly sales (ARS) should be larger than X units. It will be controlled by a new System Switch
   Parameter Name “Min ARS for Trend calculation”.
   Default value is 0.5.
The minimum number of overlaps:
   The number of overlapping weeks should be larger than 40% of the season length and more than 6 weeks (fixed) (not including week53).
This is calculated as count(LAG52).
Parameter Name “Min % of overlapped weeks for Trend calculation”
Default value is “40”.
   Statistically significant Trend: this is done using the test of significance.
new SS will allow the system to choose the following significant factor:
Parameter Name “Significant factor for Trend calculation”.
Possible setting:
   1:99%(Default), 2:97%, 3:95% or 0 (Bypass trending logic).

The trend is removed from a demand pattern only if it is statistically significant. The test of significance is performed as follows:
MEAN=average(LAG52),
STD=standard deviation(LAG52),
COUNT=count(LAG52),
STAT (Z)=MEAN/(STD/SquareRoot(COUNT))
   If STAT (Z)>1.28 (99%) then the trend is significant (should be removed). This will be controlled by SS,
   Otherwise, the trend should not be removed.

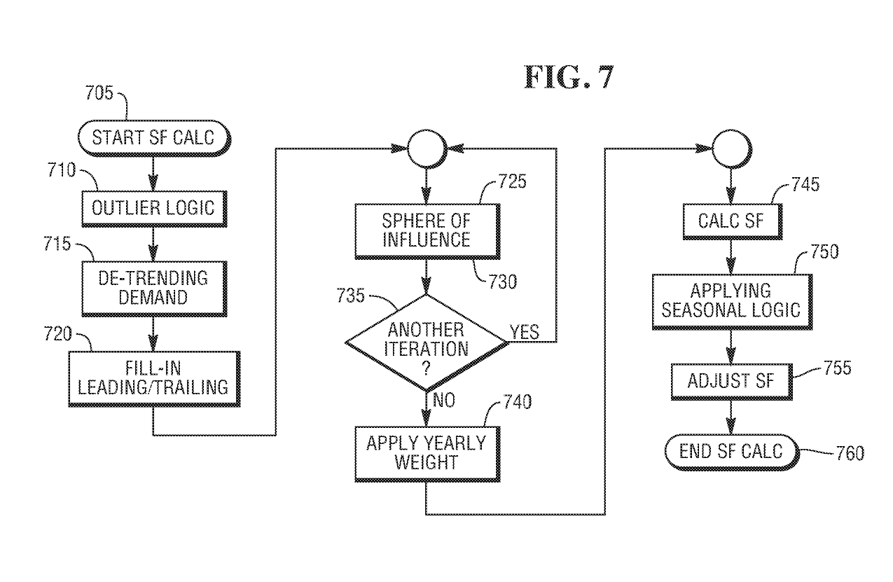

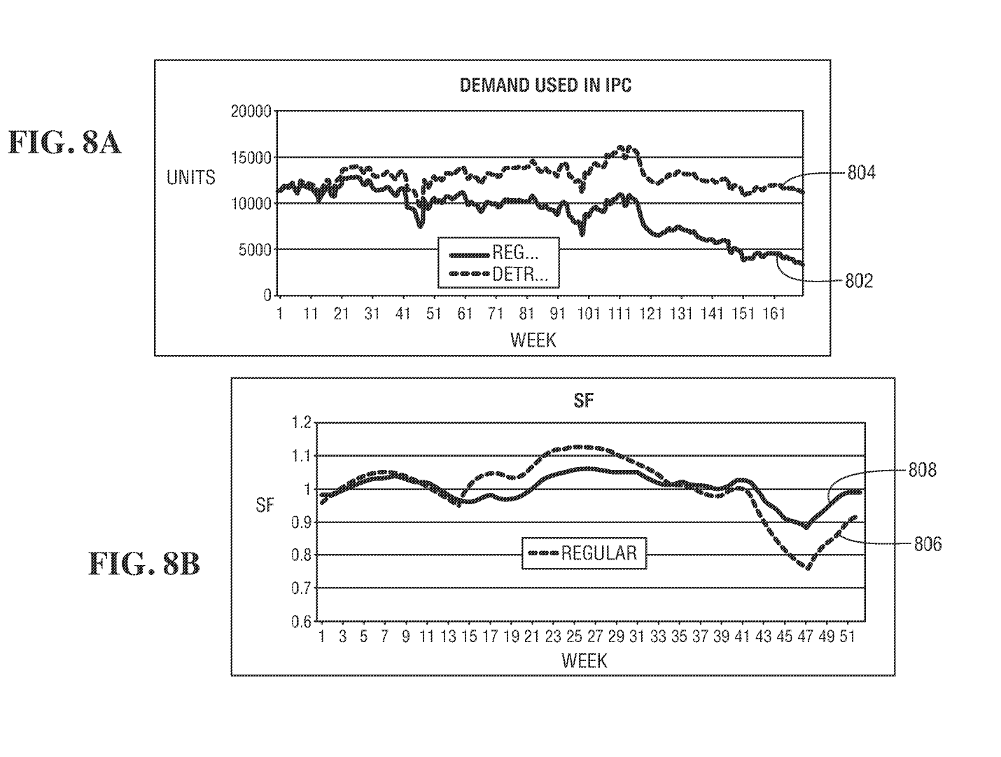

FIG. 7 provides a flow chart illustrating the method for determining seasonal factors executed within the IPC module (steps 705, 710 and 720 through 760) augmented to include the step of removing trending effects (step 715) from the calculation of seasonal factors as described above. After the de-trending logic is added into the SF calculation algorithm, the products with significance trending effect will have a major impact on seasonal pattern, as shown in the graphs of FIGS. 8A and 8B. FIG. 8A illustrates the differences between example demand data following the removal of trend effects from demand data, where graph 802 shows the demand pattern for a product or group of products, including trend data, and graph 804 shows the demand pattern following the removal of trend data. FIG. 8B illustrates the differences between example seasonal factors following the removal of trend effects from demand data, where graph 806 shows the seasonal factor pattern for the product or group of products, calculated from product demand data including trend data, and graph 808 shows the seasonal factor pattern calculated from product demand data including trend data following the removal of trend data.

### Application of Trend Factors in Long Range Forecast

The accuracy of long range demand forecast primarily depends on the following four factors:
trend factors,
seasonal factors,
cycle factors, and
random factors

Both seasonal and cycling factors are already handled by the DCM application modules, but the DCM forecasting engine is lacking one of the major forecasting factors to generate a better long-range demand forecast, which is the trend factor.

Currently, the DCM Automated Replenishment module only uses aggregated demands as an input for the long range forecast; it does not have time-series demand data for trend analysis. Without time-series data, the process is not able to calculate the actual trend.

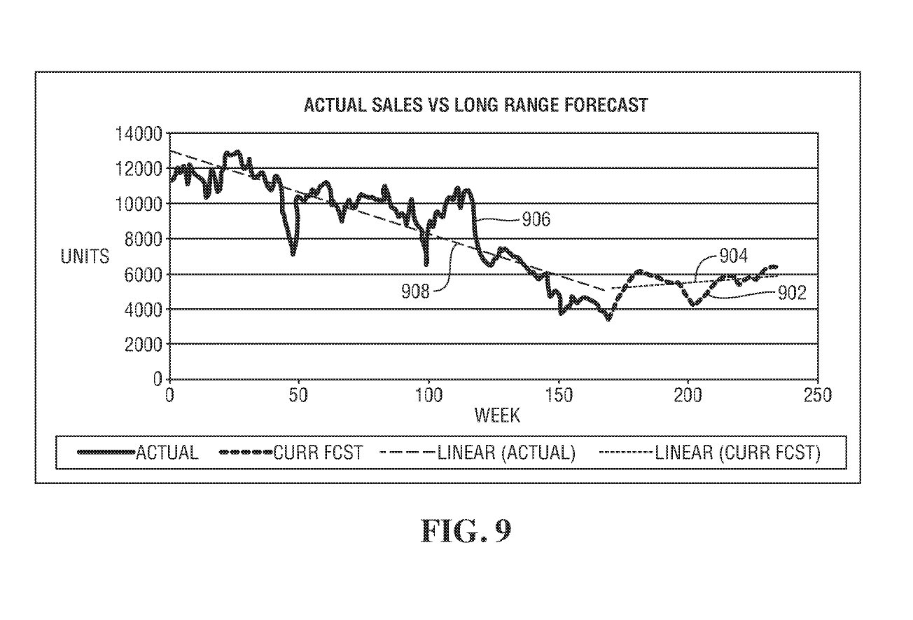

The current long range forecast determined by the DCM Automated Replenishment module attempts to simulate the trend factor by blending the last 52 weeks average sales, which can create an opposite trending effect, as illustrated in the graph of FIG. 9, where the forecast for product demand beyond 160 weeks, identified by reference numeral 902, is seen to have a trend opposite the actual demand for weeks 0 through 160, identified by reference numeral 906. Line segments 904 and 908 represent the linearized values of the forecast for product demand beyond 160 weeks, and the actual demand for weeks 0 through 160, respectively.

The improved long range forecasting methodology presented herein utilizes the calculated trend factor (at SKU/Location level) in IPC as an extra input variable to DCM Automated Replenishment module forecast engine. The following algorithm is proposed for the 65-week out forecast:
1. Remove the existing ARS blending logic.
2. If the IPC Trend did not satisfy any of the conditions then it is set to zero. It represents the trend factor is not significance to impact the long range forecast.
3. The formula to calculate the weekly forecast is changed to:

FCST[n]=ARS*SF*(n−1)*(1+IPC Trend)*SMP Bias adjustment
Where n is the week number
4. For Replacement SKU logic, new SKU and old SKU apply its own trending separately before the forecast being aggregated.

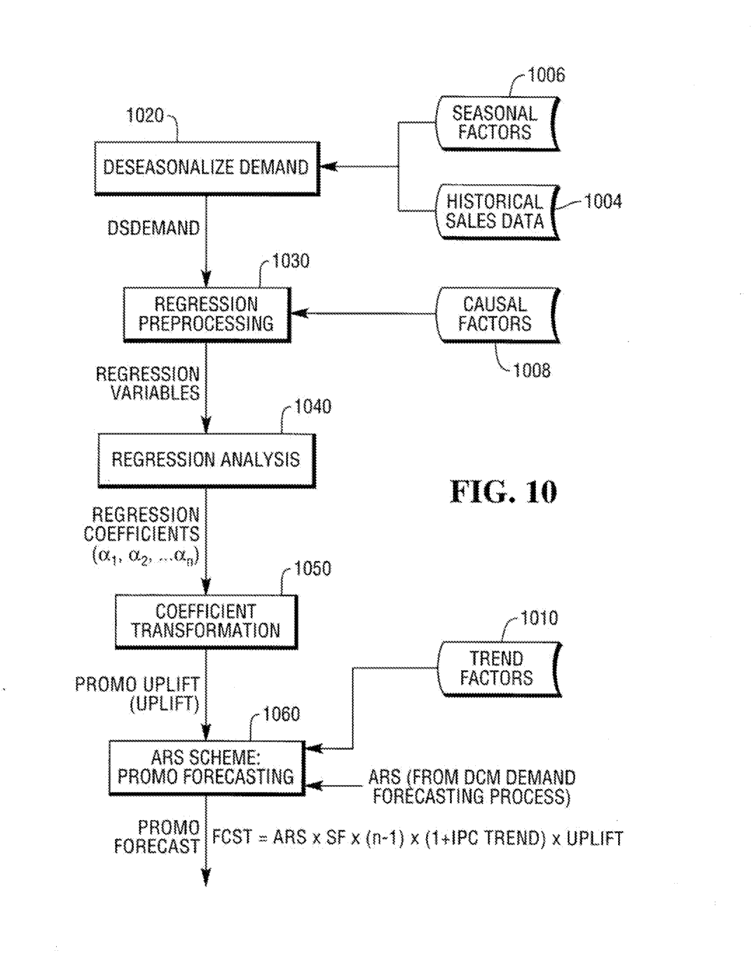

FIG. 10 is a flow chart illustrating the improved method for determining product demand forecasts with a trend factor applied to the long range product demand forecast in accordance with the present invention.

Referring to FIG. 10, historical sales data 1004, seasonal adjustment factors (SFs) 1006, and tracked causal factors 1008, are saved for each product or service offered by the retailer. In this implementation, the seasonal factors are calculated as shown in FIG. 7 to remove trending effects. Trending effects removed from the seasonal factor calculations are saved as trend factors 1010.

In step 1020, the historical demand data for products having seasonal selling patterns is adjusted, i.e., deseasonalized, by dividing the actual historical demand values by their corresponding seasonal factors according to equation 1, dsdemand_{yr,wk}=demand_{yr,wk}/SF_{wk}. The seasonally adjusted demand (dsdemand) is then used as input to the causal framework and the forecasting module of the DCM forecasting application.

In step 1030, regression preprocessing is performed to select the set of causal factors that have statistically significant effects on historical product demand, and to prepare the causal factor data 1008 for analysis.

In step 1040, regression coefficients (α₁, α₂, α₃, . . . αₙ) are calculated using the deseasonalized demand data and tracked causal factors 1008. These regression coefficients are combined in step 1050 to generate uplift coefficients for each product.

In step 1060, the uplift coefficients are combined with the DCM Average Rate of Sale (ARS) calculation results provided by the forecasting module of the DCM forecasting application for the product, the appropriate seasonal factors, and the appropriate trending factors 1010 to generate the final product demand forecast for the product:

FCST=ARS×SF×(n−1)×(1+IPC TREND)×UPLIFT

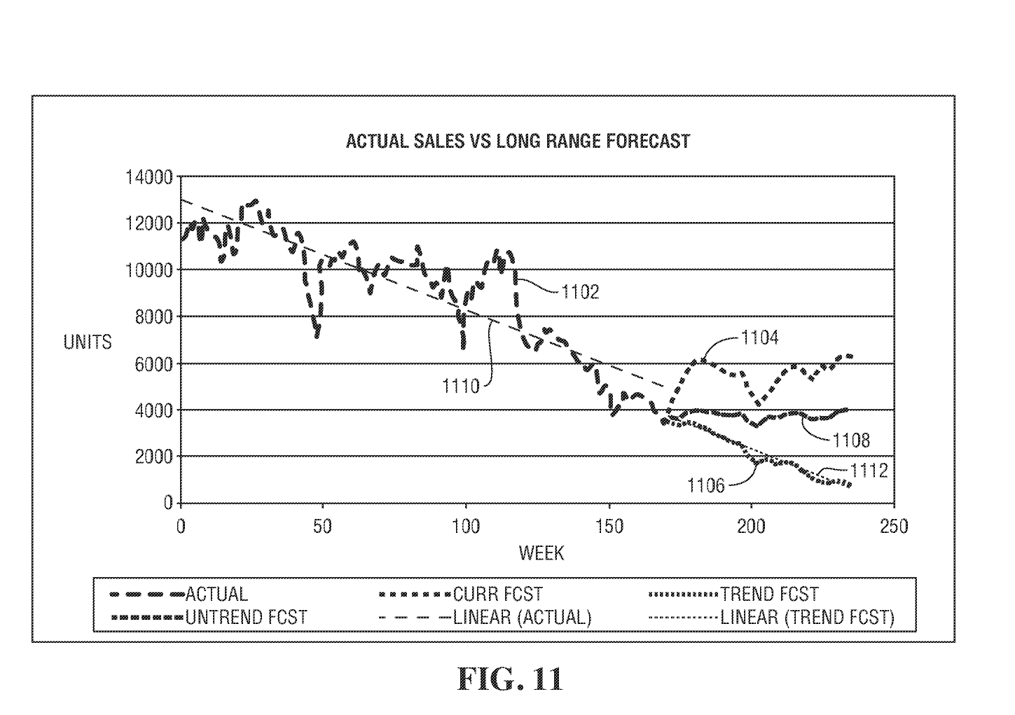

FIG. 11 is a graph providing a comparison of long range product demand forecasts including a forecast for product demand beyond 160 weeks determined without application of the present invention and seen to have a trend opposite the actual demand for weeks 0 through 160, identified by reference numeral 906; a forecast determined with trend effects removed from historical demand data 1108; and a forecast with a trend factor applied to the long range product demand forecast in accordance with the present invention 1106, also shown linearly by line 1112. The graph, based on actual customer data and results, presents a comparison between the forecasting methodology prior to incorporation of the trending logic discussed above, and the improved long range forecasting methodology including the trending logic. Actual demand for weeks 0 through 160 is identified by reference numeral 1102, and shown linearly by line 1110. The new long range forecast is seen to improve forecast accuracy and the predictive power of DCM forecast engine, with little additional computational effort or effect upon the scalability of the DCM forecasting application.

### CONCLUSION

The Figures and description of the invention provided above reveal an improved method and system for forecasting product demand using a causal methodology, based on multiple regression techniques. The improved causal method identifies year-over-year trending effects within historical product demand data, removes the trending effects from the calculation of seasonal factors used in determining product demand forecasts, calculates trend factors from the identified trending effects, and applies the trend factors and de-trended seasonal factors to initial product demand forecasts when determining final demand forecasts for the products.

Instructions of the various software routines discussed herein, are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting product demand for a product during a forecast period, the method comprising the steps of:
maintaining a database of historical product demand information;
calculating an initial demand forecast for said product during said forecast period from said historical product demand information;
identifying trend effects contained within said historical demand information;
determining trend factors for said product from said identified trend effects;
removing said trend effects from said historical demand information to determine de-trended demand information;
calculating seasonal factors for said product from said de-trended demand information; and
combining said initial demand forecast with a seasonal factor and a trend factor for said product associated with said forecast period to determine a final product demand forecast for said product.

2. The method for forecasting product demand for a product during a forecast period in accordance with claim 1, wherein:
said trend effects represent year-over-year changes in demand for said product.

3. The method for forecasting product demand for a product during a forecast period in accordance with claim 1, wherein:
said product is one of a group of products having similar sales patterns; and
said seasonal factors are determined for said group of products including said product.

4. The method for forecasting product demand for a product during a forecast period in accordance with claim 1, wherein:
said initial demand forecast is an average rate of sales for said product during prior year periods corresponding to said forecast period.

5. A method for forecasting product demand for a product during a forecast period in accordance with claim 1, wherein:
said forecast period is a forecast week;
said trend factors are year-over-year trend factors;
said seasonal factors are weekly seasonal factors;
said product demand forecast is a weekly product demand forecast determined by combining said initial demand forecast for said forecast week with a corresponding weekly seasonal factor and a corresponding weekly trend factor.

6. The method for forecasting product demand for a product during a forecast period in accordance with claim 4, wherein:
said trend effects are linear, and
said trend factors are ratios representing average weekly year-over-year changes in demand for said product.

7. A system for forecasting product demand for a product during a forecast period, comprising:
a computer storage device containing a database of historical product demand information for a plurality of products; and
a processor for executing a product forecasting application for:
calculating an initial demand forecast for said product during said forecast period from said historical product demand information;
identifying trend effects contained within said historical demand information;
determining trend factors for said product from said identified trend effects;
removing said trend effects from said historical demand information to determine de-trended demand information;
calculating seasonal factors for said product from said de-trended demand information; and
combining said initial demand forecast with a seasonal factor and a trend factor for said product associated with said forecast period to determine a final product demand forecast for said product.

8. The system for forecasting product demand for a product during a forecast period in accordance with claim 7, wherein:
said trend effects represent year-over-year changes in demand for said product.

9. The system for forecasting product demand for a product during a forecast period in accordance with claim 7, wherein:
said product is one of a group of products having similar sales patterns; and
said seasonal factors are determined for said group of products including said product.

10. The system for forecasting product demand for a product during a forecast period in accordance with claim 7, wherein:
said initial demand forecast is an average rate of sales for said product during prior year periods corresponding to said forecast period.

11. The system for forecasting product demand for a product during a forecast period in accordance with claim 7, wherein:
said forecast period is a forecast week;
said trend factors are year-over-year trend factors;
said seasonal factors are weekly seasonal factors;
said product demand forecast is a weekly product demand forecast determined by combining said initial demand forecast for said forecast week with a corresponding weekly seasonal factor and a corresponding weekly trend factor.

12. The system for forecasting product demand for a product during a forecast period in accordance with claim 11, wherein:
said trend effects are linear, and
said trend factors are ratios representing average weekly year-over-year changes in demand for said product.

13. A non-transitory computer-readable medium having a computer program for forecasting product demand for a product during a forecast period, the computer program including executable instructions that cause said computer system to:
calculate an initial demand forecast for said product during said forecast period from historical product demand information;
identify trend effects contained within said historical demand information;
determine trend factors for said product from said identified trend effects;
remove said trend effects from said historical demand information to determine de-trended demand information;
calculate seasonal factors for said product from said de-trended demand information; and
combine said initial demand forecast with a seasonal factor and a trend factor for said product associated with said forecast period to determine a final product demand forecast for said product.

14. The non-transitory computer-readable medium having a computer program for forecasting product demand for a product during a forecast period in accordance with claim 13, wherein:
said trend effects represent year-over-year changes in demand for said product.

15. The non-transitory computer-readable medium having a computer program for forecasting product demand for a product during a forecast period in accordance with claim 13, wherein:
said product is one of a group of products having similar sales patterns; and
said seasonal factors are determined for said group of products including said product.

16. The non-transitory computer-readable medium having a computer program for forecasting product demand for a product during a forecast period in accordance with claim 13, wherein:
said initial demand forecast is an average rate of sales for said product during prior year periods corresponding to said forecast period.

17. The non-transitory computer-readable medium having a computer program for forecasting product demand for a product during a forecast period in accordance with claim 13, wherein:
said forecast period is a forecast week;
said trend factors are year-over-year trend factors;
said seasonal factors are weekly seasonal factors;
said product demand forecast is a weekly product demand forecast determined by combining said initial demand forecast for said forecast week with a corresponding weekly seasonal factor and a corresponding weekly trend factor.

18. The non-transitory computer-readable medium having a computer program for forecasting product demand for a product during a forecast period in accordance with claim 17, wherein:
said trend effects are linear, and
said trend factors are ratios representing average weekly year-over-year changes in demand for said product.
